(19) United States
(12) Patent Application Publication
(10) Pub. No.: US 2012/0083294 A1
(43) Pub. Date: Apr. 5, 2012

(54) INTEGRATED IMAGE DETECTION AND CONTEXTUAL COMMANDS

(75) Inventors: Cedric Bray, Vincennes (FR); Olivier Bonnet, Paris (FR)

(73) Assignee: APPLE INC., Cupertino, CA (US)

(21) Appl. No.: 12/895,693

(22) Filed: Sep. 30, 2010

(51) Int. Cl. H04W 4/12; G06K 9/18

(52) U.S. Cl. 455/466; 382/182

(57) ABSTRACT

An image is received by a data processing system. A text recognition module identifies textual information in the image. A data detection module identifies a pattern in the textual information and determines a data type of the pattern. A user interface provides a user with a contextual processing command option based on the data type of the pattern in the textual information.

### TECHNICAL FIELD

This invention relates to the field of data extraction and, in particular, to integrated image detection and contextual commands.

### BACKGROUND

Current technologies for searching for and identifying interesting patterns in a piece of text data locate specific structures in the text. A device performing a pattern search refers to a library containing a collection of structures, each structure defining a pattern that is to be recognized. A pattern is a sequence of so-called definition items. Each definition item specifies an element of the text pattern that the structure recognizes. A definition item may be a specific string or a structure defining another pattern using definition items in the form of strings or structures. For example, a structure may give the definition of what is to be identified as a US state code. According to the definition, a pattern in a text will be identified as a US state code if it corresponds to one of the strings that make up the associated definition items, such as “AL”, “AK”, “AS”, etc. Another example structure may be a telephone number. A pattern will be identified as a telephone number if it includes a string of three numbers, followed by a hyphen or space, followed by a string of four numbers.

These pattern detection technologies only work to identify patterns in pieces of text data. In modern data processing systems, however, important data may be contained in other forms that just simple text. One example of the form of data is an image, such as JPEG (Joint Photographic Experts Group), PNG (Portable Network Graphics), TIFF (Tagged Image File Format), or other image file format. An image may be received at a data processing system, for example in an email or multimedia messaging service (MMS) message, or the image may be taken by a camera attached to the device. The image may be of a document, sign, poster, etc. that contains interesting information. Current pattern detection technologies cannot identify patterns in the image that can be used by the data processing system to perform certain commands based on the context.

### SUMMARY

Embodiments are described to identify important information in an image that can be used by a data processing system to perform certain commands based on the context of the information. A text recognition module identifies textual information in the image. To identify the textual information, the text recognition module performs a text recognition process on image data corresponding to the image. The text recognition process may include optical character recognition (OCR). A data detection module identifies a pattern in the textual information and determines a data type of the pattern. The data detection module may compare the textual information to a definition of a known pattern structure. In certain embodiments, the data type may include one of a phone number, an email address, a website address, a street address, an ISBN (International Standard Book Number), a price value, a movie title, album art, and a barcode. A user interface provides a user with a contextual processing command option based on the data type of the pattern in the textual information. The data processing system executes the contextual processing command in an application of the system. In certain embodiments, the application may include one of a phone application, an SMS (Short Message Service) and MMS (Multimedia Messaging Service) messaging application, a chat application, an email application, a web browser application, a camera application, an address book application, a calendar application, a mapping application, a word processing application, and a photo application.

In one embodiment, a facial recognition module scans the image and identifies a face in the image using facial recognition processing. The facial recognition processing extracts landmarks, such as the relative position, size, and/or shape of the eyes, nose, cheekbones, and jaw, from the face and compares the landmarks to a database of known faces. The user interface provides the user with a contextual processing command option based on the identification of the face in the image.

### BRIEF DESCRIPTION OF THE DRAWINGS

The present disclosure is illustrated by way of example, and not by way of limitation, in the figures of the accompanying drawings.

FIG. 1 is a block diagram illustrating a data processing system with integrated image detection and contextual commands, according to an embodiment.

FIG. 2 is a block diagram illustrating a data processing system with integrated image detection and contextual commands, according to an embodiment.

FIG. 3 is a flow chart illustrating an image processing method, according to an embodiment.

FIGS. 4A-4C illustrate the user experience provided by a data processing system with integrated image detection and contextual commands, according to an embodiment.

FIG. 5 is a block diagram illustrating a data processing system with integrated image detection, including facial recognition, and contextual commands, according to an embodiment.

FIG. 6 is a flow chart illustrating an image processing method with facial recognition, according to an embodiment.

FIG. 7 illustrates the user experience provided by a data processing system with integrated image detection, including facial recognition, and contextual commands, according to an embodiment.

FIG. 8 is a block diagram illustrating a data processing system according to one embodiment.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional and other changes may be made without departing from the scope of the present invention. The following detailed description is, therefore, not to be taken in a limiting sense, and the scope of the present invention is defined only by the appended claims.

Embodiments are described to identify important information in an image that can be used by a data processing system to perform certain commands based on the context of the information. In one embodiment, image data is received by the data processing system. The image data may be received, for example, in an email or multimedia messaging service (MMS) message, or the image may be captured by a camera attached to the device. A text recognition module in the data processing system performs character recognition on the image data to identify textual information in the image and create a textual data stream. The textual data stream is provided to a data detection module which identifies the type of data (e.g., date, telephone number, email address, etc.) based on the structure and recognized patterns. The data detection module causes a user interface of the data processing system to display a number of contextual processing options to the user based on the identified textual information.

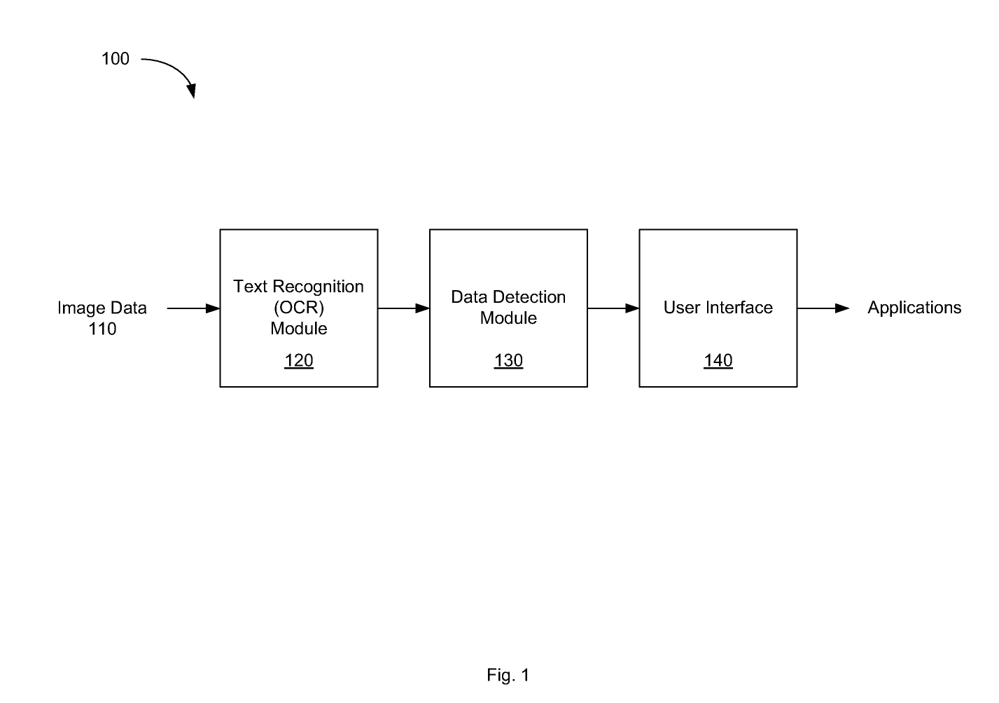

FIG. 1 is a block diagram illustrating a data processing system with integrated image detection and contextual commands, according to an embodiment. Data processing system 100 can be, for example, a handheld computer, a personal digital assistant, a laptop computer or other computer system, a cellular telephone, a network appliance, a camera, a smart phone, an enhanced general packet radio service (EGPRS) mobile phone, a network base station, a media player, a navigation device, an email device, a game console, some other electronic device, or a combination of any two or more of these data processing devices or other data processing devices.

In one embodiment, data processing system 100 includes text recognition module 120, data detection module 130, and user interface 140. Text recognition module 120 may perform text recognition processing on received image data 110. Image data 110 may be in any number of formats, such as for example, JPEG (Joint Photographic Experts Group), PNG (Portable Network Graphics), TIFF (Tagged Image File Format), or other image file format. Image data 110 may be received by data processing system 100 in a message, such as an email message, SMS (Short Message Service) message, MMS (Multimedia Messaging Service) message, chat message, or other message. The image data 110 may also correspond to an image in a web page presented by a web browser. Additionally, the image may be captured by an image capture device, such as a camera, integrated with or attached to data processing system 100. Generally, image data 110 may correspond to any image presented by a computing device to a user.

Upon receiving image data 110, text recognition module 120 may perform text recognition processing on the data to identify any textual data stored in the image represented by image data 110. In one embodiment, the text recognition processing includes OCR (optical character recognition). OCR is the recognition of printed or written text or characters by a computer. This involves photo scanning of the text, analysis of the scanned-in image, and then translation of the character image into character codes, such as Unicode or ASCII (American Standard Code for Information Interchange), commonly used in data processing. During OCR processing, the scanned-in image or bitmap is analyzed for light and dark areas in order to identify each alphabetic letter or numeric digit. When a character is recognized, it is converted into Unicode. Special circuit boards and computer chips (e.g., digital signal processing or DSP chip) designed expressly for OCR may be used to speed up the recognition process. In other embodiments, other text recognition processing techniques may be used.

Text recognition module 120 outputs a stream of character codes representing the textual data identified in the image. The stream is received by data detection module 130. In one embodiment, data detection module 130 identifies interesting patterns in the data stream, determines the type of data represented in the pattern and provides contextual processing commands to a user via user interface 140. Further details regarding the operation of data detection module 130 will be provided below.

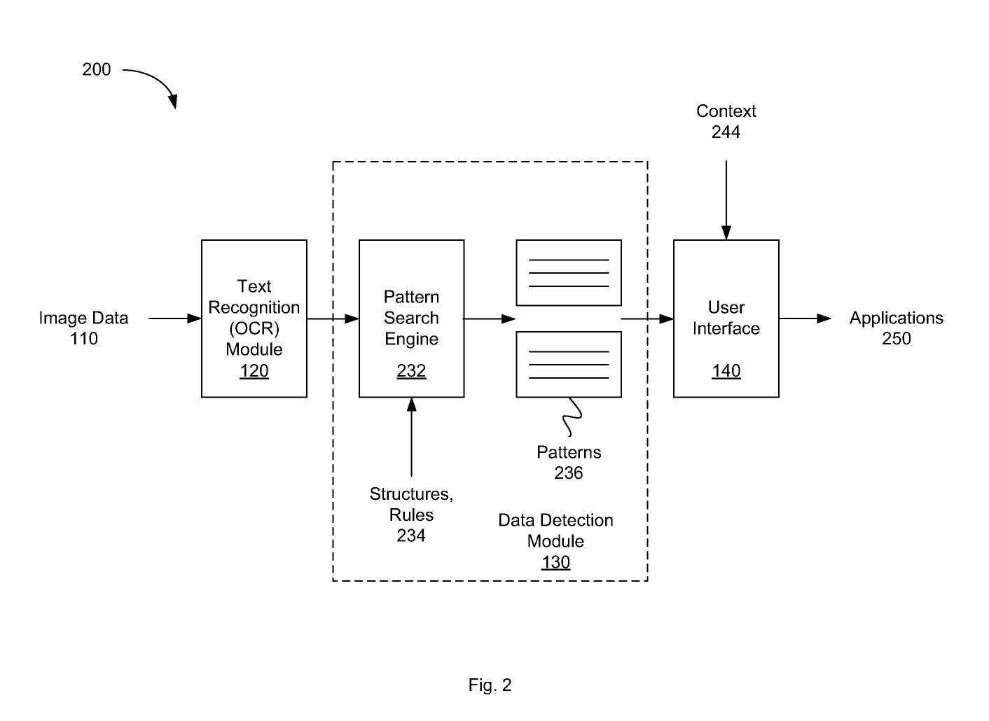

FIG. 2 is a block diagram illustrating a data processing system with integrated image detection and contextual commands, according to an embodiment. In one embodiment, data detection module 130 of data processing system 200 includes pattern search engine 232. Pattern search engine 232 receives the data stream containing the output of text recognition module 120, which is to be searched for known patterns. The data stream is searched for known patterns by engine 232 according to structures and rules 234. The known patterns may be defined by structures and rules 234. Structures and rules 234 may include a database or other listing of known patterns of characters. A pattern may be defined as a sequence of definition items. Each definition item specifies an element of the text pattern that the structure recognizes. A definition item may be a specific string or a structure defining another pattern using definition items in the form of strings or structures. For example, a structure may give the definition of what is to be identified as a street address. According to the definition, a pattern in a textual string will be identified as a street address if it has elements matching a sequence of definition items of a number, followed by a space, followed by a capitalized word, optionally followed by a known street type. Structures and rules 234 may be stored locally in a storage device of processing system 100 or may be remotely accessible over a wired or wireless network. In one embodiment, the search engine 232 may include user data in the structures of known patterns 234, which it may obtain from various data sources including user relevant information, such as a database of contact details included in an address book application or a database of favorite web pages included in a web browser. Adding user data automatically to the set of identifiable patterns renders the search user specific and thus more valuable to the user. Furthermore, this automatic addition of user data renders the system adaptive and autonomous, saving the user from having to manually add its data to the set of known patterns.

The search by engine 232 yields a certain number of identified patterns 236. These patterns 236 are then presented to a user via user interface 140. For each identified pattern, the user interface 140 may suggest a certain number of contextual command options, to be implemented in an application 250. For example, if the identified pattern is a URL address the interface 140 may suggest the action “open corresponding web page in a web browser” to the user. If the user selects the suggested action a corresponding application 250 may be started, such as, in the given example, the web browser.

The suggested actions in the contextual commands preferably depend on the context 244 of the application with which the user manipulates the image data 110. More specifically, when performing an action, the system can take into account the application context 244, such as the type of the application (word processor, email client, . . . ) or the information available through the application (time, date, sender, recipient, reference, . . . ) to tailor the action and make it more useful or “intelligent” to the user. The type of suggested actions may also depend on the data type of the associated pattern. If the recognized pattern is a phone number, other actions will be suggested than if the recognized pattern is a street address.

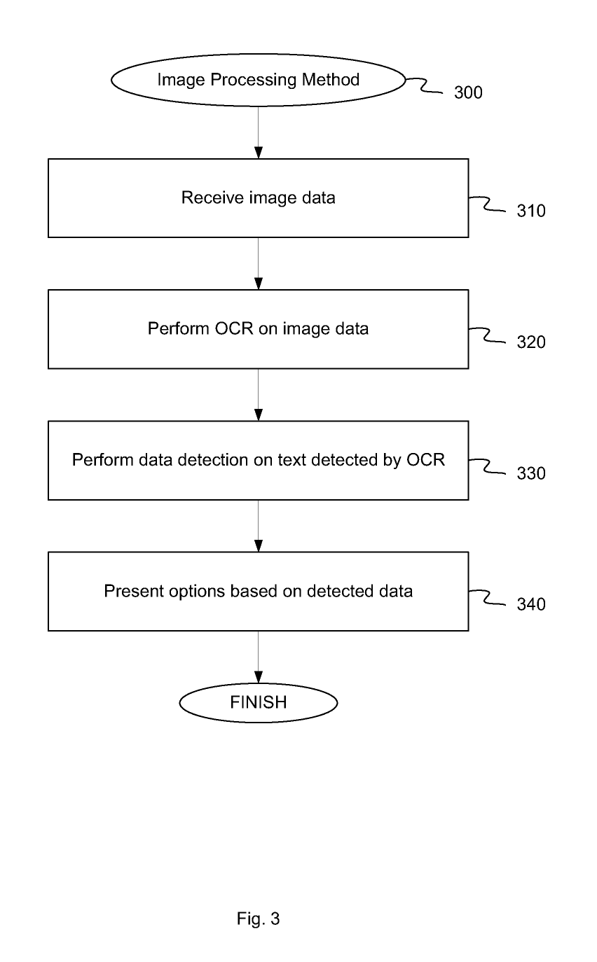

FIG. 3 is a flow chart illustrating an image processing method, according to an embodiment. The method 300 may be performed by processing logic that comprises hardware (e.g., circuitry, dedicated logic, programmable logic, microcode, etc.), software (e.g., instructions run on a processing device to perform hardware simulation), or a combination thereof. The processing logic is configured identify a textual pattern in image data and present contextual command options based on the context of the data. In one embodiment, method 300 may be performed by data processing system 200, as shown in FIG. 2.

Referring to FIG. 3, at block 310, method 300 receives image data. For purposes of explanation, let us assume that a user of a desktop computer is currently viewing an image received as an attachment to an email message, however, in other embodiments, the image data may be received through any of a number of methods, including those discussed above. The image is displayed to the user on a display device. Upon opening the image, at block 320, method 300 scans the image data for recognized characters and outputs a stream of character code. In one embodiment, the scan is performed by text recognition module 120. In one embodiment, the method 300 is initiated automatically upon opening the image, however in other embodiments, method 300 may be initiated in response to a user command.

The stream of character code output by text recognition module 120 is received by pattern search engine 232, which searches the textual stream for known patterns at block 330. In one embodiment, the pattern search is done in the background without the user noticing it. In a data processing system having an attached pointing device, such as a mouse, when the user places his mouse pointer over a text element that has been recognized as an interesting pattern 236 having actions associated with it, this text element is visually highlighted to the user in user interface 140. In a data processing system with a touch-screen, the patterns 236 identified in the text may be highlighted automatically, without the need of a user action. In some embodiments, the non-highlighted areas of the image may be darkened to increase the visual contrast. At block 340, method 300 presents a number of contextual command options to the user based on the detected data. The highlighted area may include a small arrow or other graphical element. The user can click on this arrow in order to visualize actions associated with the identified pattern 236 in a contextual menu. The user may select one of the suggested actions or commands, which is executed in a corresponding application 250.

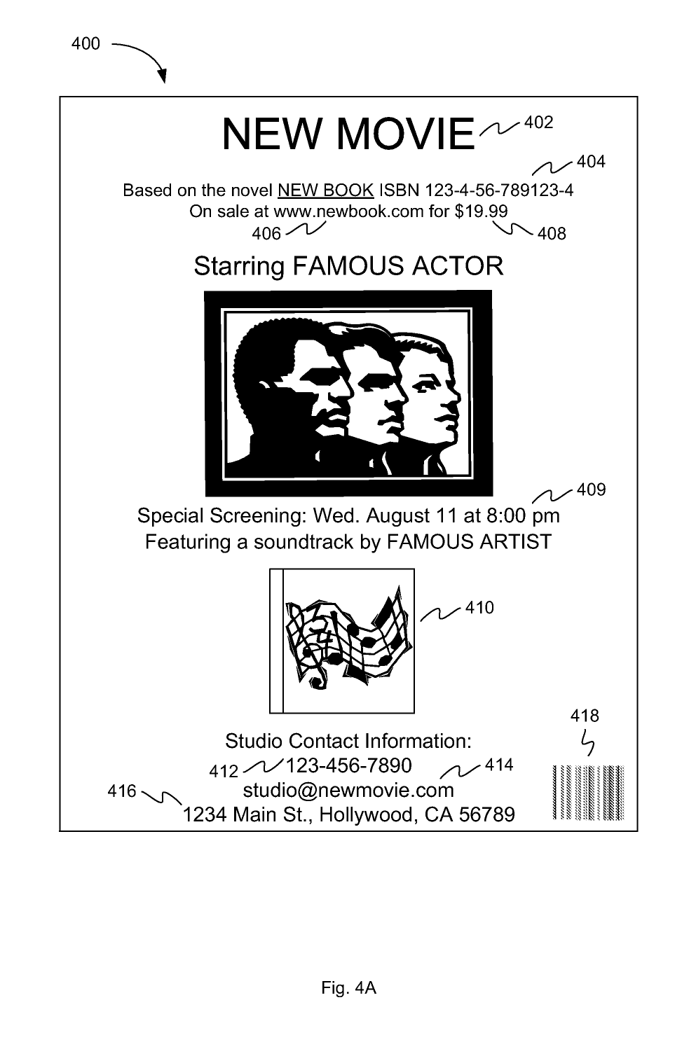

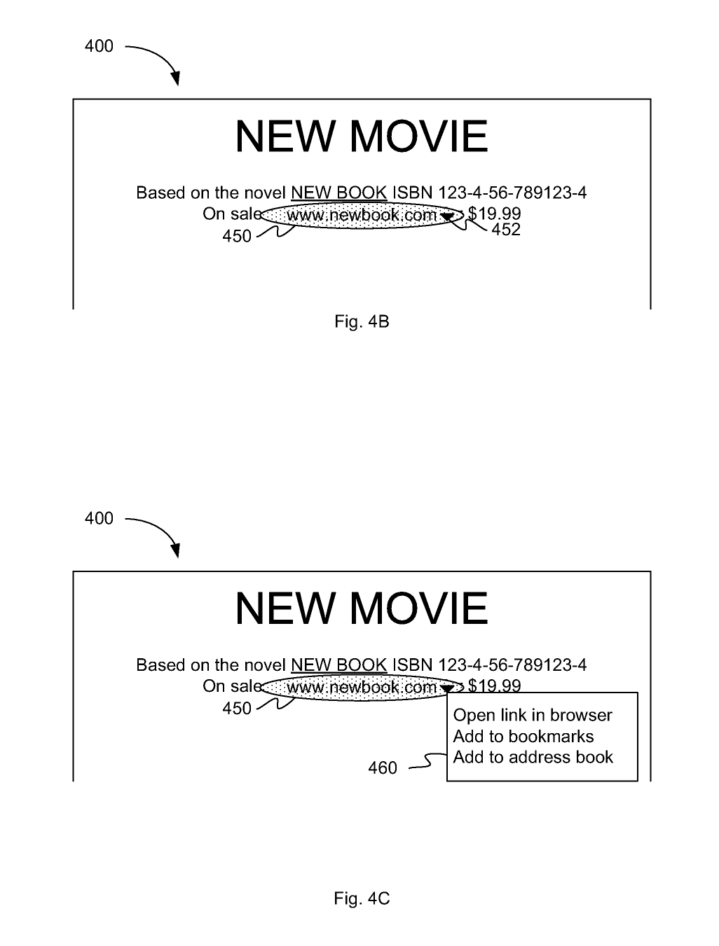

FIG. 4A illustrates the user experience provided by a data processing system with integrated image detection and contextual commands, according to an embodiment. In this example, FIG. 4A illustrates an image 400 of a promotional movie poster. The image 400 may be received by a data processing system, such as data processing system 200, in any of the manners described above, such as for example, it may be captured by a camera attached to data processing system 200. The image 400 contains a number of pieces of textual data which may be of interest to a user of data processing system 200. Either automatically upon image capture, or at the request of the user by an input command, text recognition module 120 may scan the image 400 for recognized characters and outputs a stream of character code. Pattern search engine 232 searches the textual stream for known patterns and classifies them according to the provided structures and rules 234. In this example, the following patterns may be recognized: movie title 402; ISBN (International Standard Book Number) 404; website address 406; price value 408; album art 410; phone number 412; email address 414; street address 416; and barcode 418.

In one embodiment, as shown in FIG. 4B, as a user positions a cursor or touches a touch sensitive display over one of the recognized patterns, the pattern field is highlighted 450 and a small arrow or other graphical element 452 is presented. The user may click on arrow 452 to bring up a context menu 460, as shown in FIG. 4C. Context menu 460 provides a list of contextual command options from which the user may select an operation to be performed. The contextual commands may be different depending on the data type of the textual pattern recognized by data detection module 130. In this example, the highlighted pattern field is website address 406. For website address 406, the corresponding commands in context menu 460 may include opening the website in a browser window in data processing system 200, adding the website address to a list of bookmarks, and adding the website address to an address book, which may include adding it to an existing contact entry or creating a new contact entry.

Although not illustrated, the following commands may be relevant to the various identified patterns described above. For movie title 402, the commands may include offering more information on the movie (e.g., showtimes, playing locations, trailer, ratings, reviews, etc.) which may be retrieved from a movie website(s) over a network, offering to purchase tickets to an upcoming showing of the movie if still playing in theaters, and offering to purchase or rent the movie from an online merchant, if available. For ISBN number 404, the commands may include offering more information on the book (e.g., title, author, publisher, reviews, excerpts, etc.) and offering to purchase the book from an online merchant, if available. For price value 408, the commands may include adding the price to an existing note (e.g., a shopping list) and comparing the prices to other prices for the same item at other retailers. For date and time 409, the commands may include adding an associated event to an entry in a calendar application or a task list, which may include adding it to an existing entry or creating a new calendar entry. For album art 410, the commands may include offering more information on the album (e.g., artist, release date, track list, reviews, etc.), offering to by the album from an online merchant, and offering to buy concert tickets for the artist. For phone number 412, the commands may include calling the phone number, sending a SMS or MMS message to the phone number, and adding the phone number to an address book, which may include adding it to an existing contact entry or creating a new contact entry. For email address 414, the commands may include sending an email to the email address, and adding the email address to an address book, which may include adding it to an existing contact entry or creating a new contact entry. For street address 416, the commands may include showing the street address on a map, determining directions to/from the street address from/to a current location of the data processing system or other location, and adding the street address to an address book, which may include adding it to an existing contact entry or creating a new contact entry. For barcode 418, the commands may include offering more information on the product corresponding to the barcode which may be retrieved from a website or other database, and offering to buy the product from an online merchant, if available. In response to the user selection of one of the provided contextual command options, the processing system may cause the action to be performed in an associated application.

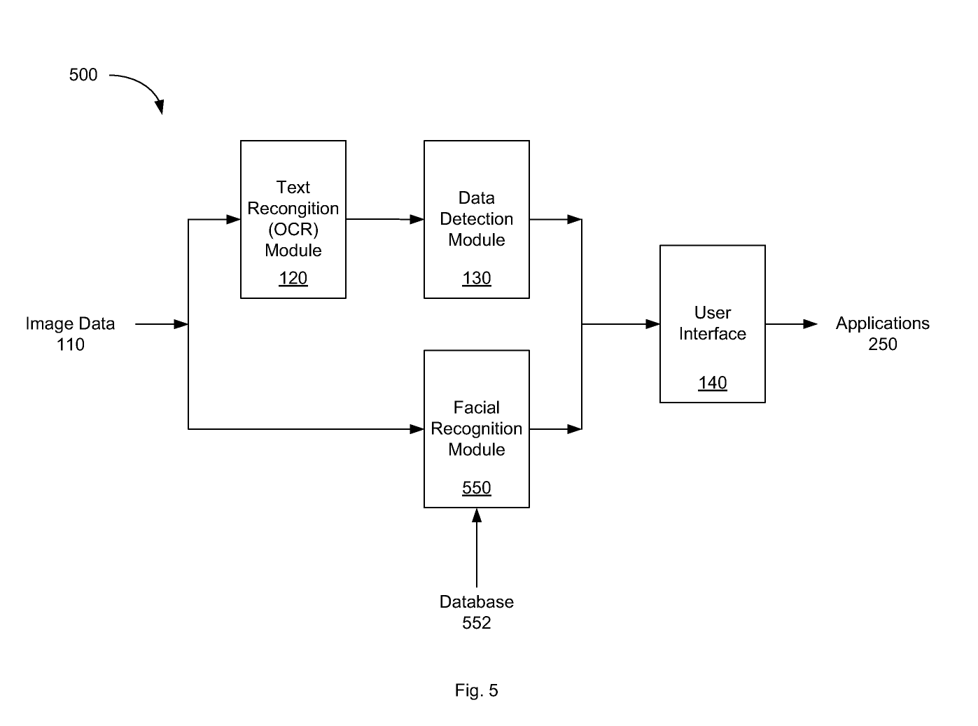

FIG. 5 is a block diagram illustrating a data processing system with integrated image detection, including facial recognition, and contextual commands, according to an embodiment. In one embodiment, data processing system 500 can be similar to data processing systems 100 and 200 described above. Data processing system 500 may additionally include facial recognition module 550 to scan image data 110 for recognized faces.

In one embodiment, facial recognition module scans an image represented by image data 110 after text recognition module 120 has identified textual data and data detection module 130 has identified and recognizable patterns in the textual data. In other embodiments, however, facial recognition module may scan the image before or in parallel with text recognition module 120 and/or data detection module 130.

Upon receiving image data 110, facial recognition module 550 may perform facial recognition processing on the data to identify any faces in the image represented by image data 110. In one embodiment, the facial recognition processing employs one or more facial recognition algorithms to identify faces by extracting landmarks, or features, from an image of the subject's face. For example, an algorithm may analyze the relative position, size, and/or shape of the eyes, nose, cheekbones, and jaw. These features are then used to search for other images with matching features. The features may be compared with known images in a database 552 which may be stored locally in data processing system 500 or remotely accessible over a network. Other algorithms normalize a gallery of face images and then compress the face data, only saving the data in the image that is useful for face detection. A probe image is then compared with the face data. Generally, facial recognition algorithms can be divided into two main approaches: geometric, which looks at distinguishing features; or photometric, which is a statistical approach that distills an image into values and compares the values with templates to eliminate variances. The facial recognition algorithms employed by facial recognition module may include Principal Component Analysis with eigenface, Linear Discriminate Analysis, Elastic Bunch Graph Matching fisherface, the Hidden Markov model, neuronal motivated dynamic link matching, or other algorithms.

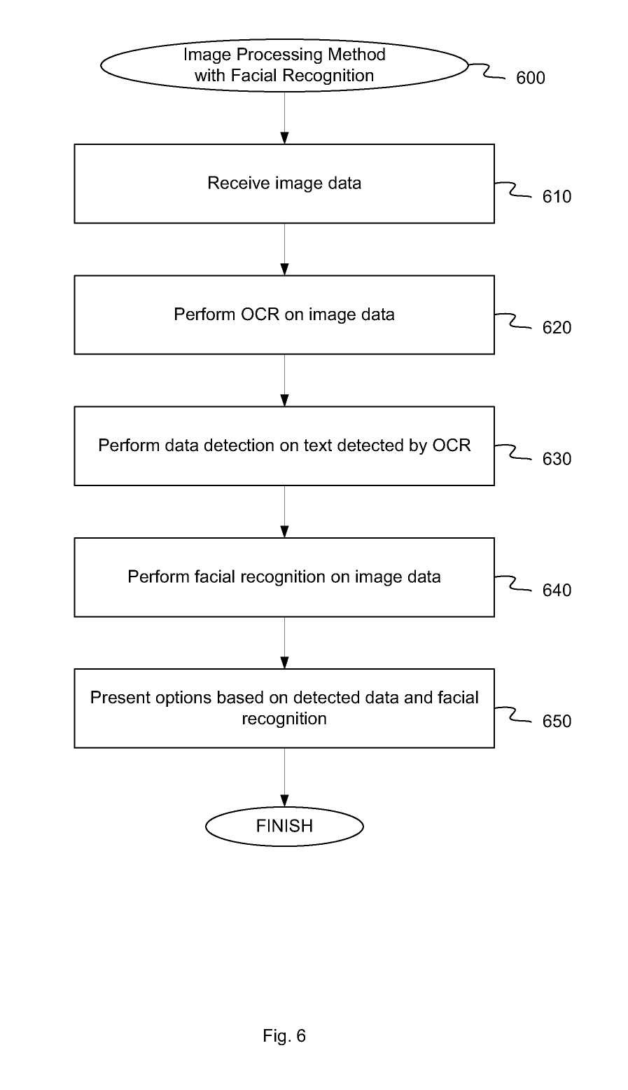

FIG. 6 is a flow chart illustrating an image processing method with facial recognition, according to an embodiment. The method 600 may be performed by processing logic that comprises hardware (e.g., circuitry, dedicated logic, programmable logic, microcode, etc.), software (e.g., instructions run on a processing device to perform hardware simulation), or a combination thereof. The processing logic is configured to identify a textual pattern in image data and any recognizable faces in the image and present contextual commands based on the context of the data. In one embodiment, method 600 may be performed by data processing system 500, as shown in FIG. 5.

Referring to FIG. 6, at block 610, method 600 receives image data. For purposes of explanation, let us assume that a user of a desktop computer is currently viewing an image received as an attachment to an email message, however the image data may be received through any of a number of methods, including those discussed above. The image is displayed to the user on a display device. Upon opening the image, at block 620, method 600 scans the image data for recognized characters and outputs a stream of character codes. In one embodiment, the scan is performed by text recognition module 120. The stream is received by pattern search engine 232, which searches the textual stream for known patterns at block 630. In one embodiment, the pattern search is done in the background without the user noticing it.

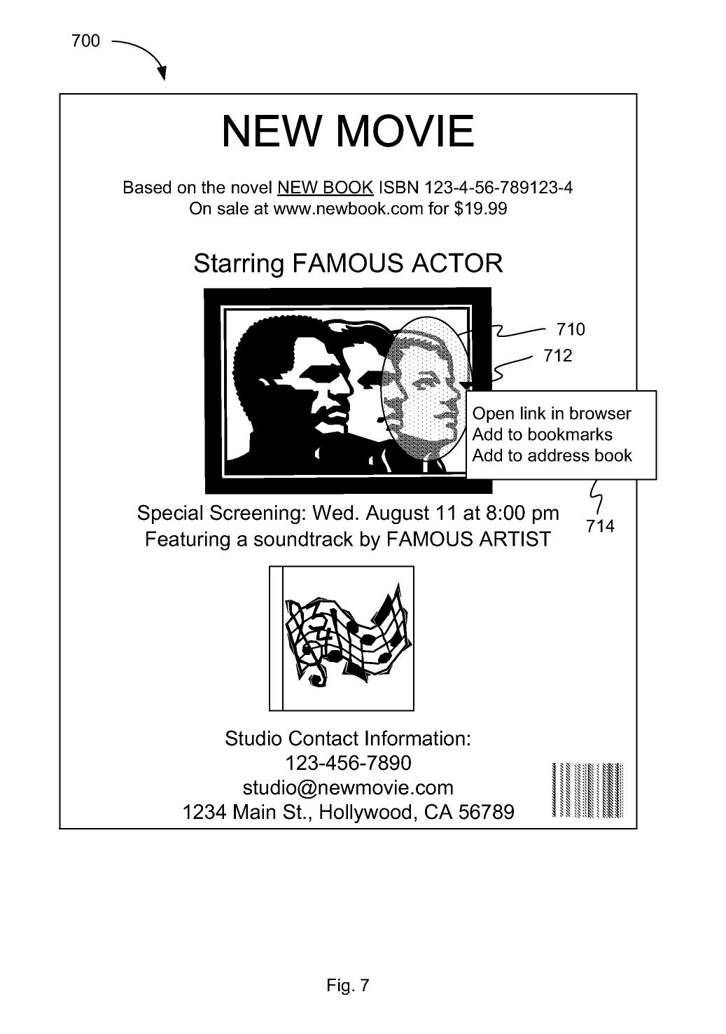

At block 640, method 600 performs a facial recognition scan on the image data. In one embodiment, the scan is performed by facial recognition module 550. Facial recognition module 550 may compare any recognized faces in the image to a database 552 of known faces in order to identify the recognized faces. In one embodiment, the facial recognition scan may be performed in parallel with the OCR and data detection processes performed at blocks 620 and 630. In a data processing system having an attached pointing device, such as a mouse, when the user places his mouse pointer over a text element or face that has been recognized, the text element or face is visually highlighted to the user in user interface 140. In a data processing system with a touch-screen, the text elements and faces identified in the image may be highlighted automatically, without the need of a user action. At block 650, method 600 presents a number of contextual commands to the user based on the identified text elements and faces. As shown in FIGS. 4B, 4C and 7, the highlighted area 450, 710 may include a small arrow or other graphical element 452, 712. The user can click on this arrow in order to visualize actions 460, 714 associated with the identified text element or face in a contextual menu. The user may select one of the suggested actions or commands, which is executed in a corresponding application 250. In this example, the highlighted field is a detected face. For the detected face, the corresponding commands in context menu 740 may include confirming the recognized identity of the detected face, adding the face to a contact list or address book, which may include adding it to an existing contact entry or creating a new contact entry, performing any action in the contact entry associated with the detected face (e.g., calling a phone number in the contact entry, sending an email to an email address in the contact entry, pulling up a social networking website associated with the contact entry, etc.), or searching the internet for information on the detected face. In response to the user selection of one of the provided contextual command options, the processing system may cause the action to be performed in an associated application 250.

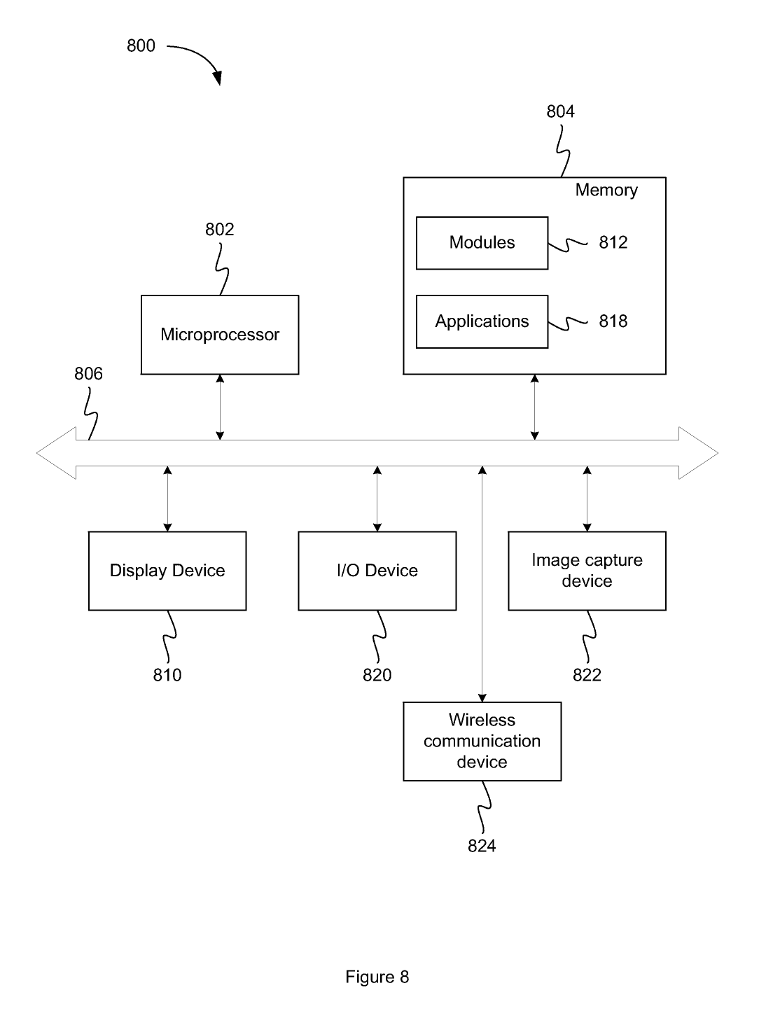

FIG. 8 illustrates a data processing system according to one embodiment. The system 800 may include a processing device, such as processor 802, and a memory 804, which are coupled to each other through a bus 806. The system 800 may also optionally include a display device 810 which is coupled to the other components through the bus 806. One or more input/output (I/O) devices 820 are also connected to bus 806. The bus 806 may include one or more buses connected to each other through various bridges, controllers, and/or adapters as is well known in the art. The I/O devices 820 may include a keypad or keyboard or a cursor control device or a gesture-sensitive device such as a touch or gesture input panel. An image capture device 822, such as a camera, may also be connected to bus 806. The camera (e.g., an optical sensor such as a charged coupled device (CCD) or a complementary metal-oxide semiconductor (CMOS) optical sensor) can be utilized to facilitate camera functions, such as recording photographs and video clips. A wireless communication device 824 may also be connected to bus 806. Communication functions can be facilitated through one or more wireless communication devices 824, which can include radio frequency receivers and transmitters and/or optical (e.g., infrared) receivers and transmitters. The specific design and implementation of the communication device 824 can depend on the communication network(s) over which the processing system is intended to operate. For example, the processing system may include communication devices 824 designed to operate over a GSM network, a GPRS network, an EDGE network, a Wi-Fi or WiMax network, and/or a Bluetooth™ network.

Memory 804 may include modules 812 and application 818. In at least certain implementations of the system 800, the processor 802 may receive data from one or more of the modules 812 and application 818 and may perform the processing of that data in the manner described herein. In at least certain embodiments, modules 812 may include text recognition module 120, data detection module 130, user interface 140 and facial recognition module 550. Processor 802 may execute instructions stored in memory on image data as described above with reference to these modules. Applications 818 may include a phone application, an SMS/MMS messaging application, a chat application, an email application, a web browser application, a camera application, an address book application, a calendar application, a mapping application, a word processing application, a photo application, or other applications. Upon receiving a selection of a contextual command through I/O device 820, processor 802 may execute the command in one of these corresponding applications.

Embodiments of the present invention include various operations described herein. These operations may be performed by hardware components, software, firmware, or a combination thereof. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Certain embodiments may be implemented as a computer program product that may include instructions stored on a machine-readable medium. These instructions may be used to program a general-purpose or special-purpose processor to perform the described operations. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Additionally, some embodiments may be practiced in distributed computing environments where the machine-readable medium is stored on and/or executed by more than one computer system. In addition, the information transferred between computer systems may either be pulled or pushed across the communication medium connecting the computer systems.

The digital processing devices described herein may include one or more general-purpose processing devices such as a microprocessor or central processing unit, a controller, or the like. Alternatively, the digital processing device may include one or more special-purpose processing devices such as a digital signal processor (DSP), an application specific integrated circuit (ASIC), a field programmable gate array (FPGA), or the like. In an alternative embodiment, for example, the digital processing device may be a network processor having multiple processors including a core unit and multiple microengines. Additionally, the digital processing device may include any combination of general-purpose processing devices and special-purpose processing devices.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

What is claimed is:

1. A method, comprising:
receiving, by a data processing system, an image;
identifying textual information in the image;
identifying a pattern in the textual information and determining a data type of the pattern; and
providing a user with a contextual processing command option based on the data type of the pattern in the textual information.

2. The method of claim 1, wherein identifying textual information comprises performing a text recognition process on image data corresponding to the image.

3. The method of claim 2, wherein the text recognition process comprises optical character recognition (OCR).

4. The method of claim 1, wherein identifying a pattern and determining a data type of the pattern comprises comparing the textual information to a definition of a known pattern structure.

5. The method of claim 1, wherein the data type comprises one of a phone number, an email address, a website address, a street address, a date, a time, an ISBN (International Standard Book Number), a price value, a movie title, album art, and a barcode.

6. The method of claim 1, further comprising:
executing the contextual processing command in an application of the data processing system.

7. The method of claim 1, wherein the application comprises one of a phone application, an SMS (Short Message Service) and MMS (Multimedia Messaging Service) messaging application, a chat application, an email application, a web browser application, a camera application, an address book application, a calendar application, a mapping application, a word processing application, and a photo application.

8. The method of claim 1, further comprising:
identifying a face in the image using facial recognition processing, wherein the facial recognition processing extracts landmarks from the face and compares the landmarks to a database of known faces; and
providing the user with a contextual processing command option based on the identified face.

9. A non-transitory machine readable storage medium storing instructions which when executed cause a data processing system to perform a method comprising:
receiving an image;
identifying textual information in the image;
identifying a pattern in the textual information and determining a data type of the pattern; and
providing a user with a contextual processing command option based on the data type represented by the pattern in the textual information.

10. The storage medium of claim 9, wherein identifying textual information comprises performing a text recognition process on image data corresponding to the image.

11. The storage medium of claim 10, wherein the text recognition process comprises optical character recognition (OCR).

12. The storage medium of claim 9, wherein identifying a pattern and determining a data type of the pattern comprises comparing the textual information to a definition of a known pattern structure.

13. The storage medium of claim 9, wherein the data type comprises one of a phone number, an email address, a website address, a street address, a date, a time, an ISBN (International Standard Book Number), a price value, a movie title, album art, and a barcode.

14. The storage medium of claim 9, wherein the method further comprises:
executing the contextual processing command in an application of the data processing system.

15. The storage medium of claim 14, wherein the application comprises one of a phone application, an SMS (Short Message Service) and MMS (Multimedia Messaging Service) messaging application, a chat application, an email application, a web browser application, a camera application, an address book application, a calendar application, a mapping application, a word processing application, and a photo application.

16. The storage medium of claim 9, wherein the method further comprises:
identifying a face in the image using facial recognition processing, wherein the facial recognition processing extracts landmarks from the face and compares the landmarks to a database of known faces; and
providing the user with a contextual processing command option based on the data type represented by the pattern in the textual information.

17. A system, comprising:
a processor; and
a memory coupled to the processor, the memory storing:
a text recognition module configured to receive an image and identify textual information in the image;
a data detection module configured to identify a pattern in the textual information and determine a data type represented by the pattern in the textual information; and
a user interface configured to provide a user with a contextual processing command option based on the data type represented by the pattern in the textual information.

18. The system of claim 17, wherein when the text recognition module identifies textual information, the processor is configured to perform a text recognition process on image data corresponding to the image.

19. The system of claim 18, wherein the text recognition process comprises optical character recognition (OCR).

20. The system of claim 17, wherein identifying a pattern and determining a data type of the pattern comprises comparing the textual information to a definition of a known pattern structure.

21. The system of claim 17, wherein the data type comprises one of a phone number, an email address, a website address, a street address, a date, a time, an ISBN (International Standard Book Number), a price value, a movie title, album art, and a barcode.

22. The system of claim 17, wherein the processor executes the contextual processing command in an application of the system.

23. The system of claim 22, wherein the application comprises one of a phone application, an SMS (Short Message Service) and MMS (Multimedia Messaging Service) messaging application, a chat application, an email application, a web browser application, a camera application, an address book application, a calendar application, a mapping application, a word processing application, and a photo application.

24. The system of claim 17, the memory further storing:
a facial recognition module configured to identify a face in the image using facial recognition processing, wherein the facial recognition processing extracts landmarks from the face and compares the landmarks to a database of known faces; and
providing the user with a contextual processing command option based on the data type represented by the pattern in the textual information.
